(19) United States
(12) Patent Application Publication
(10) Pub. No.: US 2002/0021843 A1
(43) Pub. Date: Feb. 21, 2002

(54) Signal processing device, signal processing method and file generating method

(76) Inventors: Takahiro Fukuhara, Kanagawa (JP); Seiji Kimura, Chiba (JP)

Correspondence Address: RADAR, FISHMAN & GRAUER, P.L.L.C, Suite 501, 1233 20th Street, NW, Washington, DC, 20036, US

(21) Appl. No.: 09/920,768

(22) Filed: Aug. 3, 2001

(30) Foreign Application Priority Data
Aug. 11, 2000 (JP) P2000-245400

(51) Int. Cl. G06K 9/36; G06K 9/46

(52) U.S. Cl. 382/235

(57) ABSTRACT

The compatibility of a JP2 file conforming to the JPEG 2000 Standard for still pictures and an MJ2 file conforming to the Motion-JPEG 2000 Standard that is a version for moving pictures is improved to facilitate file generation and decoding to a great convenience of the user.

The input data 111 may include a Motion-JPEG 2000 file (MJ2 file) generated by adding meta information to the code streams of an encoded moving picture having a plurality of frames to a JP2 file containing one or more than one JPEG 2000 code stream and header information. The MJ2 file analyzer 9 reads out the leading JPEG 2000 code stream in the JP2 file and transmits it to the JPEG 2000 decoder 10, while it discards or disregards all the remaining JPEG 2000 code streams in the JP2 file other than the leading code stream.

### BACKGROUND OF THE INVENTION

1. Field of the Invention

This invention relates to a signal processing device, a signal processing method and a file generating method for decoding a coded file containing a code stream of an encoded moving picture. More particularly, the present invention relates to a signal processing device, a signal processing method and a file generating method for decoding a Motion JPEG 2000 file generated by adding a code stream of an encoded moving picture having a plurality of frames and meta data to a JPEG 2000 file comprising a JPEG 2000 code stream and header information.

2. Related Background Art

The JPEG (Joint Photographic coding Experts Group) system adopted as standard by the ISO (International Organization for Standardization) is known as typical conventional image compression system. The JPEG system is adapted mainly to compression coding of still pictures using a DCT (discrete cosine transform) and can provide good coded images and decoded images when bits are allocated at a high rate. However, as the bit allocation rate is reduced, the phenomenon of distorted blocks that is specific to the DCT becomes apparent and the reproduced image becomes degraded, if subjectively.

Meanwhile, recently efforts have been paid to develop coding systems for dividing an image into a plurality of bands by means of a filter referred to as filter bank and realized by combining a high pass filter and a low pass filter and encoding the image on a band by band basis. Of such systems, the wavelet coding system has been attracting attention as feasible new technology that can replace the DCT because it is free from the problem of distorted blocks specific to the DCT that becomes remarkable particularly when the compression ratio is high.

JPEG 2000 (currently being investigated by ISO/IEC/JTC1SC29/WG1, the organization identical with the JPEG) is a format that is expected as next generation international standard system succeeding the JPEG system and whose Part 1 is Scheduled to be adopted as standard in December, 2000. With JPEG 2000, it has been decided to adopt the wavelet transform in place of the DCT as transformation system to be used for the purpose of image compression.

While the current JPEG format normally involves the use of an extension of “.jpg”, it represents a pure code stream. On the other hand, JFIF is a standardized format proposed by C-Cube Microsystems for adding image information to the code stream produced as a result of compression according to JPEG and storing them in a file. It has been accepted widely as a standard of the industry. A JPEG file mostly refers to a file formed according to the JFIF system.

With JPEG 2000, again, while a pure code stream is referred to as “jp2c”, a file format defined to include additional information may be used when the software of an ordinary digital camera or a PC is involved. Then, an extension of “.jp2” will be used. Similarly, a specific file format (using “.mj2”) will be used for Motion-JPEG 2000, a standard for motion pictures.

While the file format (JP2) according to JPEG 2000 for still pictures and the file format (MJ2) according to Motion-JPEG 2000 for moving pictures are different from each other, it is important to make them compatible from the viewpoint of expanding the scope of application. For instance, while recently marketed still digital cameras that can be used for taking a moving picture are adapted to output a file of a moving picture, it is necessary for them to make it possible to decode and display each frame thereof independently as a still image.

Similarly, it will be very convenient if it is possible to independently decode and display each frame of the moving picture recorded in an MJ2 file as a still image, while maintaining the compatibility of MJ2 for a file of a moving picture and JP2 for a file of still pictures.

### BRIEF SUMMARY OF THE INVENTION

In view of the above identified circumstances, it is therefore the object of the present invention to provide a signal processing device, a signal processing method and a file generating method that can make it possible to make a file containing code streams of encoded still pictures such as a JP2 file conforming to the JPEG 2000 file format and a file containing code streams of an encoded moving picture such as an MJ2 file conforming to the Motion-JPEG 2000 file format compatible relative to each other for the convenience or the user and maintain the compatibility in such a way that the means for reading an MJ2 file can decode and display a moving picture in addition to a still picture and the means dedicated to reading a JP2 file can also decode an MJ2 file and operate as MJ2 file generating means.

According to the invention, the above object is achieved by providing a signal processing device and a signal processing method for decoding a first coded file containing one or more than one first code streams and header information and also a second coded file containing code streams of an encoded moving picture having a plurality of frames and meta data added thereto, said device and method being adapted to reading the leading first code stream in the first coded file, discarding or disregarding all the first code streams in the first coded file other than the leading code stream and decoding the read out leading code stream in the first coded file.

Preferably, the signal processing device comprises a means for decoding an MJ2 file containing a plurality of code streams and meta data and sorting them into components, said code streams and meta data being synthetically combined in said file, a means for decoding the sorted code streams of encoded still pictures and an encoded moving picture, using a JPEG 2000 decoding means, and a means for outputting a decoded image, using the synchronizing information in the meta data.

In another aspect of the invention, there is provided a file generating method comprising:

a step of coding pictures including a plurality of frames according to a first coding standard and generating first code streams;

a still image extracting step of extracting only the code stream of a desired frame out of the first code streams;

a moving image extracting step of extracting the code streams of all or part of the plurality of frames of said first code streams;

a step of generating meta data relating to the code streams of the plurality of frames extracted in said moving image extracting step; and

a step of generating a second coded file by combining all the first code streams and the meta data.

Preferably, the file generating method is carried out by a device comprising a JPEG 2000 coding means for coding independently the images of said frames on a frame by frame basis, a means for recording separately the code streams of still images and those of a moving image, a means for generating meta data including synchronizing data and a means for generating an MJ2 file by synthetically combining all the code streams of still images and a moving image and the meta data.

As described above, according to the invention, there are provided a signal processing device and a signal processing method for decoding a first coded file containing one or more than one first code streams and header information and also a second coded file containing code streams of an encoded moving picture having a plurality of frames and meta data added thereto, said device and method being adapted to read the leading first code stream in the first coded file and discarding or disregarding all the first code streams in the first coded file other than the leading code stream and decode the read out leading code stream in the first coded file. Thus, the first coded file and the second code file snow an enhanced degree of mutual compatibility so that both a moving picture and still pictures can be decoded and displayed with ease.

As described above, in another aspect of the invention, there is provided a file generating method comprising a step of coding pictures having a plurality of frames according to a first coding standard and generating first code streams, a still image extracting step of extracting only the code stream of a desired frame out of the first code streams, a moving image extracting step of extracting the code streams of all or part of the plurality of frames of said first code streams, a step of generating meta data relating to the code streams of the plurality of frames extracted in said moving image extracting step and a step of generating a second coded file by combining all the first code streams and the meta data. Therefore, the generated second coded file is compatible with the first coded file to a large extent.

More specifically, because the JP2 file format defined in the JPEG 2000 Standard and the MJ2 file format defined in the Motion-JPEG 2000 Standard that is a version of the former for moving pictures are highly compatible relative to each other, the MJ2 file decoder can read either file and decode both still and moving pictures to a great convenience on the part of the user. Additionally, as meta data are generated when generating an MJ2 file for moving pictures so that files of audio streams may be generated in addition to files of video streams. Therefore, an MJ2 file may be generated and decoded so as to synchronize a picture and the related sound.

### BRIEF DESCRIPTION OF THE SEVERAL VIEWS OF THE DRAWING

FIG. 1 is a schematic block diagram of an embodiment of signal processing device according to the invention;

FIG. 2 is a schematic illustration of the JPEG 2000 (JP2) file format and the Motion-JPEG 2000 (MJ2) file format;

FIG. 3 is a schematic illustration of an operation of reading a Motion-JPEG 2000 (MJ2) file;

FIG. 4 is a schematic block diagram of a device that can be used for a file generating method according to the invention;

FIG. 5 is a schematic illustration of the configuration of a coded bit stream defined as syntax of JPEG 2000 Standard; and

FIG. 6 is a schematic illustration of the data structure of consecutive pictures showing a continuous coded bit stream.

### DETAILED DESCRIPTION OF THE INVENTION

Now, a signal processing device, a signal processing method and a file generating method according to the invention will be described in greater detail by referring to the accompanying drawing that illustrates preferred embodiments of the invention. The embodiments will be described particularly in terms of reading and generating a JPEG 2000 file containing one or more than one JPEG 2000 code streams employed as codes streams of still pictures and header information and also a Motion-JPEG 2000 file that can be generated by adding a code stream of an encoded moving picture containing a plurality of frames and meta data.

1st Embodiment

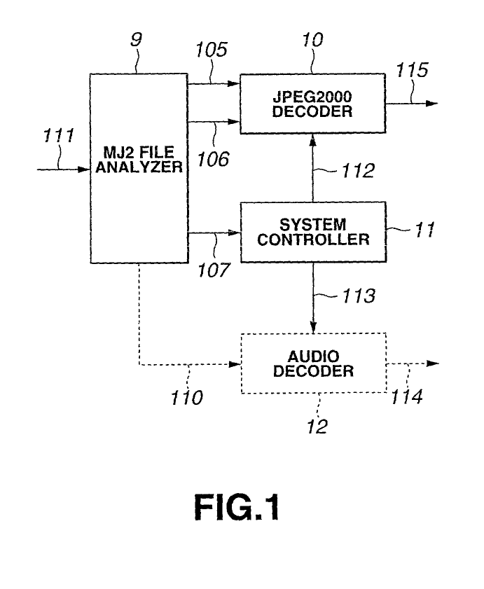

Now, the first embodiment of signal processing device according to the invention will be described by referring to FIGS. 1 through 3 of the accompanying drawing. This first embodiment comprises a means for receiving as input a JPEG 2000 file containing one or more than one JPEG 2000 code streams employed as codes streams of still pictures and header information and also a Motion-JPEG 2000 file that can be generated by adding a code stream of an encoded moving picture containing a plurality of frames and meta data, reading the leading JPEG 2000 code stream in the JPEG 2000 file and transmitting it to a JPEG 2000 decoder and also a means for discarding or disregarding all the JPEG 2000 code streams in the JPEG 2000 file other than the leading code stream.

FIG. 1 schematically illustrates the configuration of a device for reading a Motion-JPEG 2000 file (MJ2 file) comprising an MJ2 file code analyzer 9, a JPEG 2000 decoder 10 and a system controller 11 along with, if necessary, an audio decoder 12.

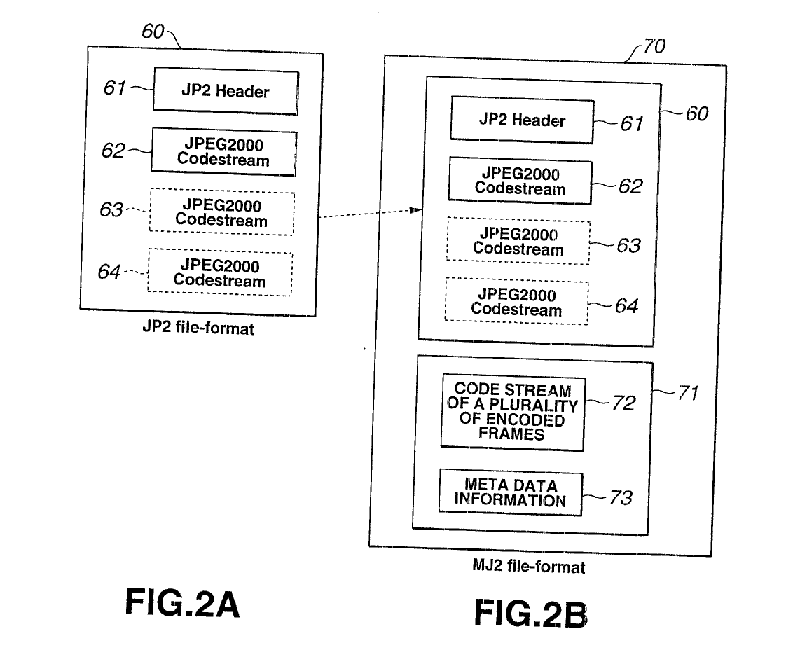

Referring to FIG. 1, input data 111 is a Motion-JPEG 2000 file (MJ2 file). (B) in FIG. 2 shows the file format of an MJ2 file. In FIG. 2, (A) shows the file format of a JPEG 2000 file (3P2 file) conforming to the JPEG 2000 Standard. Note that the JP2 file 60 in (B) is used in MJ2 file 70 shown in (B) of FIG. 2 without any modification.

In other words, the format of (A) in FIG. 2 is defined in the current JPEG 2000 Part-1 FDC (Final Committee Draft) and the JP2 file 60 contains at least a JP2 Header 61 storing header related information including the size and color information of the image and a JPEG 2000 code stream 62. If necessary, it may contain additional JPEG 2000 code streams 63, 64, . . . Note that all the remaining parts of the format that are not related to the present invention are omitted.

(B) in FIG. 2 shows a file format that can be used for an MJ2 file (Motion-JPEG 2000 file) 70 and contains the JP2 file 60 (in the upper half). Thus, the compatibility of the JP2 file format and the MJ2 file format can be maintained by analyzing and/or generating the JP2 file 60. The MJ2 file 70 additionally contains a part 71 including a code stream 72 of an encoded moving picture having a plurality of frames and meta data 73. The meta data 73 include the frame rate at which the moving picture is displayed and the timings of decoding and outputting the code stream as information relating to the code stream. The meta data may include sound information and text information.

Returning to FIG. 1, the MJ2 file analyzer 9 receives the input data 111 of the MJ2 file and isolate the components. As a result, the input data are sorted to a code stream of encoded still pictures 105, a code stream of an encoded moving picture 106 and meta data 107, of which both the code stream of encoded still pictures 105 and the code stream of an encoded moving picture 106 are transmitted to the JPEG 2000 decoder 10 so that one or more than one decoded images 115 are produced as a result of a decoding operation conforming to the JPEG 2000 Standard of the JPEG 2000 decoder 10. It will be needless to say that the decoded moving picture includes the existing number of frames.

Meanwhile, the meta data 107 are input to the system controller 11 and displayed or output synchronously with the decoded images 115 and the decoded sounds 114 according respectively to the image synchronism control signal 112 and the sound synchronism control signal 113 output from the system controller 11.

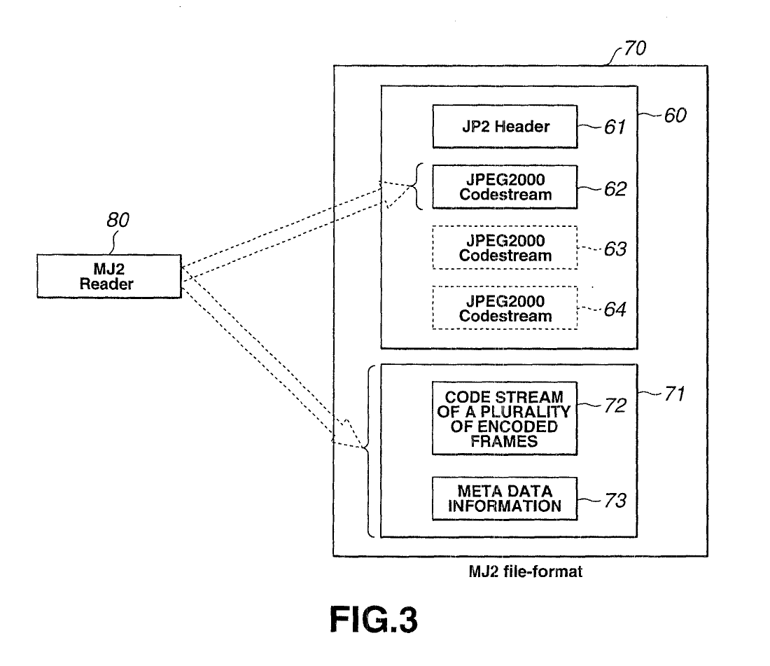

The above operation will be described by referring to FIG. 3. The Box 80 of the MJ2 Reader (which may also be referred to as MJ2 Motion Reader) in FIG. 3 corresponds to the MJ2 file analyzer 9 in FIG. 1. On the other hand, as described above in terms of the configuration of the JP2 file format shown in (A) of FIG. 2, JP2 file 60 may contain more than one code streams. However, the Box 80 of the MJ2 Reader in FIG. 3 reads only the leading code stream and discards or disregards all the remaining code streams.

On the other hand, the code stream of the encoded moving picture 106 shown in FIG. 1 can be obtained from the MJ2 file analyzer 9 by reading the code stream of the encoded moving picture having a plurality of frames and stored in the code stream 72 of a plurality of encoded frames shown in FIG. 3.

When analyzing the code stream of the encoded moving picture having a plurality of frames and transmitting the code stream of each encoded frame to the JPEG 2000 decoder 10, both the code streams of encoded still pictures 105 and the code stream of the encoded moving picture 106 are transmitted to and decoded by the JPEG 2000 decoder 10 because the MJ2 file 70 normally contains both code streams 105 and 106.

Now, with regard to Motion-JPEG 2000, the number of frames that can output per second can be modified for a moving picture. Then, there may arise a problem that a moving picture that may appear to be one displayed by fast forward-moving or slow forward-moving of a recording medium can be output if the original coding frame rate of the code stream 106 of the encoded moving picture is strictly observed for the output. Therefore, the meta data 107 is transmitted to the system controller 11 so that the moving picture may be displayed at the actually specified frame rate. Then, the system controller 11 transmits a control signal 112 showing the timings of decoding and outputting the decoded image 115 to the JPEG 2000 decoder 10 so that the decoded image 115 is output at the specified timing.

The broken lines in FIG. 1 indicate the audio decoder 12, which is useful when the MJ2 file contains sound information. The MJ2 file format can be made to contain not only still pictures and a moving picture but also meta data including sounds and text information. It is also possible for the MJ2 file format to contain sounds in a compressed or uncompressed form.

In the instance of FIG. 1, if the code stream 110 of encoded sounds as analyzed by the MJ2 file analyzer 9 contains compressed and encoded sounds, they are decoded by the audio decoder 12 and the original sounds are emitted typically from a loud speaker as audio data 114. Since they have to be synchronized with the moving picture, a control signal 113 specifying the timing of outputting the sounds is transmitted to the audio decoder 12 on the basis of the meta data 107 so that the sounds 114 and the moving picture 115 may be ultimately synchronized.

2nd Embodiment

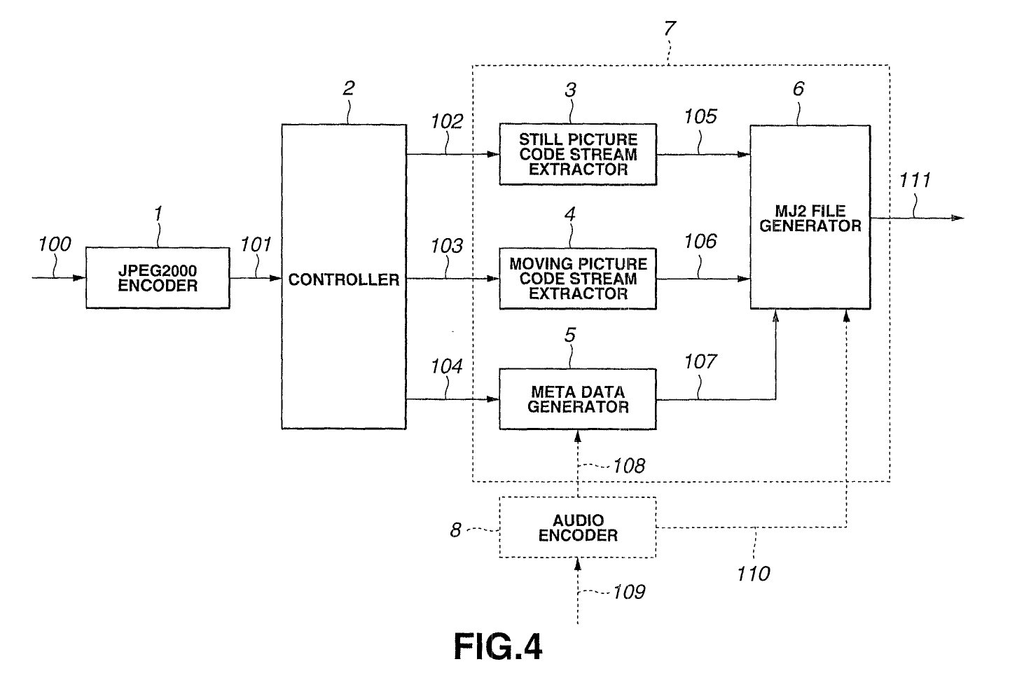

Now, the second embodiment of the invention that is an embodiment of file generating method for generating an MJ2 file confirming to the Motion-JPEG 2000 file format will be described. FIG. 4 schematically illustrates the configuration of device to which the embodiment of method for generating an MJ2 file is applicable. Referring to FIG. 4, it comprises means for coding a picture having one or more than one frames by a JPEG 2000 coding means and extracting/recording only a desired frame out of the JPEG 2000 code stream for one or more than one frames (a code stream of an encoded still picture recording means), a means for extracting/recording all or part of the JPEG 2000 code stream for one or more than one frames (a code stream of an encoded moving picture recording means), a means for storing the data recorded by the above two means in separate areas, a means for generating meta data in addition to video information on said plurality of frames and a means for generating a file of said all the JPEG 2000 code streams and said meta data.

More specifically, the device of FIG. 4 comprises a JPEG 2000 encoder 1, a controller 2, a still picture code stream extractor 3, a moving picture code stream extractor 4, a meta data generator 5, an MJ2 file generator 6 and an audio encoder 8. The part enclosed by broken lines in FIG. 4 indicates the MJ2 file generator 7.

Referring to FIG. 4, the input image 100 (a moving picture or a still picture) is encoded by the JPEG 2000 encoder 1 according to the JPEG 2000 Standard and outputs a code stream 101. If the code stream 101 is that of a still picture, the controller 2 transmits it to the still picture code stream extractor 3 as a code stream 102 of an encoded still picture. If, on the other hand, the code stream 101 is that of a moving picture, the controller 2 transmits it to the moving picture code stream extractor 4 as a code stream 103 of an encoded moving picture.

If the code stream 101 is that of a moving picture, control information 104 containing meta data indicating the frame rate per second and the length of the moving picture (in terms of the number of seconds of the sequence, the number of all the frames or the like) and other pieces of information is transmitted to the meta data generator 5.

If there is a code stream 110 of encoded sound optionally generated by compressing the input audio signal 109 by the audio encoder 8, audio meta data 108 will also be transmitted to the meta data generator 5. Then, the meta data generated by the meta data generator 5 include synchronizing information for both the sounds and the moving picture. The meta data 73 are packed in the MJ2 file 70 as shown in FIG. 2 or FIG. 3 and output as data 107 shown in FIG. 4.

The code stream 102 of the encoded still picture is packed in the code stream 62 of the leading Box in the JPEG 2000 code streams contained in the MJ2 file 60 in the MJ2 file 70 shown in FIG. 2 or 3 and output as code stream 105 of a still picture. Similarly, the code stream 103 of the encoded moving picture is packed in the plurality of code streams 72 of the encoded moving picture in the MJ2 file 70 and output as code stream 106 of a moving picture.

Then, the generated data 105, 106 and 107 and the code stream 110 of the encoded sounds that is added whenever necessary are transmitted to the MJ2 file generator 6, which MJ2 file generator 6 outputs them as a single file (MJ2 file) 111. Thus, this embodiment of MJ2 file generating method operates in a manner as described above.

3rd Embodiment

This third embodiment is adapted to use the leading frame or an appropriate intermediary frame (e.g., the most characteristic frame) selected out of all the frames of the code stream of an encoded moving picture or a frame other than the frames of the code stream of the encoded moving picture for the code stream of an encoded still picture.

The operation of selecting the leading frame of all the frames of the code stream of an encoded moving picture will be generally most easy. The JPEG 2000 encoder 1 is required only to record or store the leading frame of an encoded moving picture as the code stream of a still picture. When, on the other hand, selecting and recording an intermediary frame of the code stream of an encoded moving picture as the code stream of an encoded still picture, an interrupt operation needs to be carried out under external control. It is also possible to select and record the leading frame of the code stream of an encoded moving picture as the code stream of an encoded still picture and also frames starting from the second frame of the code stream of an encoded moving picture as the code stream of another encoded still picture. It is also possible to select and record a code stream that is independent of the code stream of the encoded moving picture as the code stream of a still picture.

4th Embodiment

This fourth embodiment is adapted to make each of all the frames of the code stream of an encoded moving picture start from with an SOC (start of code) code indicating the start of a code as defined by the JPEG 2000 Standard and end with an EOC (end of code) code indicating the end of a code as defined by the JPEG 2000 Standard.

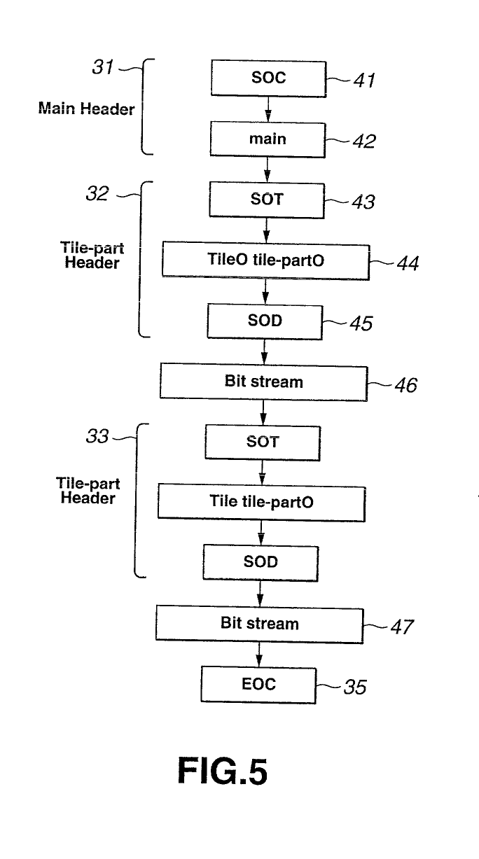

FIG. 5 schematically illustrates the configurations of the programs of a code stream of a frame as defined by the JPEG 2000 Standard.

The JPEG 2000 Standard defines a means for dividing an image to be encoded into tiles of appropriate dimensions and encoding each of the tiles. In order to realize such an operation, the parameters include a main header 31 and a plurality of combinations of a tile-part header 32 or 33 and a bit stream 46 or 47, whichever appropriate, as shown in FIG. 5. While only two combinations including tile-part headers 32 and 33 and bit streams 46 and 47 are shown in FIG. 5, three or more than three combinations may be used.

The main header 31 has an SOC (start of code stream) 41 indicating the start of a code stream and a main header marker segment (main) 42, while the Tile-part header 32 has an SOT (start of tile-parts) 44 indicating the start of tile-parts, a tile-part header marker segment (Tile0 of Tile-part0) 44 and a code SOD (start of data) 45. Bit stream 46 that is the coded data of the tile-part is arranged after the code SOD located at the end of the Tile-part Header 32,. An EOC (end of code stream) 35 is arranged at the end of the code stream to indicate the end of the code.

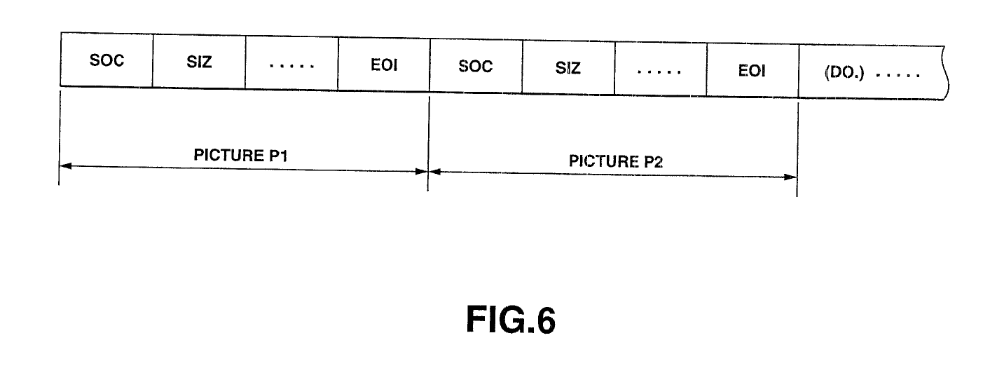

As clear from FIG. 5, a code stream starts with a code SOC (start of code) and end with an EOC (end of code). FIG. 6 shows a format obtained by extending it to a moving picture. More specifically, FIG. 6 shows a continuous bit stream obtained by sequentially arranging bit streams of still pictures on the basis of the arrangement of FIG. 5. Each picture (frame) starts with an SOC and ends with an EOC as shown in FIG. 5. FIG. 6 shows a continuous bit stream obtained by sequentially arranging pictures P1, P2, . . . Thus, each frame (picture) starts with an SOC and ends with an EOC as independent frames.

5th Embodiment

This fifth embodiment is adapted to detects an SOC (start of code) code indicating the start of the next code conforming to the JPEG 2000 Standard or terminates the current decoding operation when there does not exist any EOC (end of code) code indicating the end of a code conforming to the JPEG 2000 standard in one of the frames of the code stream of an encoded moving picture as analyzed by the file analyzer 9 of FIG. 1.

If the EOC code of a frame is missing for some reason or another, the arrangement of the first embodiment for reading a file conforming to the Motion-JPEG 2000 Standard can move to the operation of decoding the next frame so that there may not arise any problem, provided that the arrangement includes a means for detecting the SOC code of the next frame. Alternatively, the decoding operation may be terminated without detecting the SOC code of the next frame when the EOC code of the current frame is missing.

With this embodiment of the invention, the JP2 file format defined by in the JPEG 2000 Standard and the MJ2 file format defined in the Motion-JPEG 2000 Standard can be made compatible relative to each other so that the MJ2 file analyzer can read either file and decode both still pictures and a moving picture to a great convenience on the pall of the user.

Additionally, when generating an MJ2 file for a moving picture, meta data and an audio code stream can be generated simultaneously and put into a file along with the code stream of the moving picture so that both the moving picture and the related sounds may be recorded and displayed in a synchronized manner. This arrangement is particularly advantageous for presentations and also for efficiently filing meta data.

Specific examples of applications of JPEG 2000 and Motion-JPEG 2000 include electronic cameras, cam-corders, video codecs for monitor images, codecs for VTRs for broadcasting, portable/mobile video transmission/reception terminals (PDAs), printers, codecs for satellite/medical images, software modules of such codecs, games, compressors/decompressors for textures to be used for three-dimensional CGs and software modules of such compressors/decompressors.

The present invention is by no means limited to the above described embodiments. For example, it may be needless to say that the first coded file and the second coded file are not limited to JPEG 2000 files and Motion-JPEG 2000 files.

What is claimed is:

1. A signal processing device adapted to receive as input a first coded file containing one or more than one first code streams and header information and also a second coded file containing code streams of an encoded moving picture having a plurality of frames and meta data added thereto, said device comprising:
a file analyzing means for reading the leading first code stream in the first coded file and discarding or disregarding all the first code streams in the first coded file other than the leading code stream; and
a decoding means for decoding the leading code stream in said first coded file as read out by said file analyzing means.

2. The signal processing device according to claim 1, wherein said first coded file is a file in the file format conforming to JPEG 2000 and said second coded file is a file in the file format conforming to Motion-JPEG 2000.

3. The signal processing device according to claim 1, wherein said file analyzing means is adapted to decode said code stream of the encoded moving picture having a plurality of frames and transmits the code stream of each frame to said decoding means.

4. The signal processing device according to claim 1, further comprising:
a system control means for controlling the decoding operation and the output of said decoding means;
said file analyzing means being adapted to analyze the meta data of said plurality of frames and send them to said system control means;
said system control means being adapted to control the operation of said decoding means of decoding and outputting said code stream of the encoded moving picture having a plurality of frames and display the decoded moving picture in a synchronized manner.

5. The signal processing device according to claim 4, further comprising:
a sound decoding means for decoding a code stream of encoded sounds;
said second coded file containing a code stream of encoded sounds;
said system control means being adapted to so control said decoding means and said sound decoding means as to synchronize the decoded moving picture having a plurality of frames from said decoding means and the sounds decoded by said sound decoding means.

6. The signal processing device according to claim 2, wherein said file analyzing means either detects the SOC (start of code) code indicating the start of the next code conforming to the JPEG 2000 Standard or terminates the current decoding operation when there does not exist any EOC (end of code) code indicating the end of a code conforming to the JPEG 2000 Standard in one of the frames of the code stream of an encoded moving picture as analyzed by the file analyzer.

7. A signal processing method adapted to decode a first coded file containing one or more than one first code streams and header information and also a second coded file containing code streams of an encoded moving picture having a plurality of frames and meta data added thereto, said method comprising:
a file analyzing step for reading the leading first code stream in the first coded file and discarding or disregarding all the first code streams in the first coded file other than the leading code stream; and
a decoding step for decoding the leading code stream in said first coded file as read out in said file analyzing step.

8. The signal processing method according to claim 7, wherein said first coded file is a file in the file format conforming to JPEG 2000 and said second coded file is a file in the file format conforming to Motion-JPEG 2000.

9. A file generating method comprising:
a step of coding pictures including a plurality of frames according to a first coding standard and generating first code streams;
a still image extracting step of extracting only the code stream of a desired frame out of the first code streams;
a moving image extracting step of extracting the code streams of all or part of the plurality of frames of said first code streams;
a step of generating meta data relating to the code streams of the plurality of frames extracted in said moving image extracting step; and
a step of generating a second coded file by combining all the first code streams and the meta data.

10. The file generating method according to claim 9, wherein said first coded file is a file in the file format conforming to JPEG 2000 and said second coded file is a file in the file format conforming to Motion-JPEG 2000.

11. The file generating method according to claim 9, wherein the code stream extracted in said still image extracting step is the leading frame of all the frames of the code stream extracted in said moving image extracting step.

12. The file generating method according to claim 9, wherein said code stream extracted in said still image extracting step is the most characteristic code stream of the code stream extracted in said moving image extracting step and specified by externally input information.

13. The file generating method according to claim 9, wherein said code stream extracted in said still image extracting step is that of a frame of the code stream extracted in said moving image extracting step.

14. The file generating method according to claim 9, wherein said code stream extracted in said still image extracting step is independent of the code stream extracted in said moving image extracting step.

15. The file generating method according to claim 10, wherein said code stream extracted in said moving image extracting step starts with an SOC (start of code) code and ends with an EOC (end of code) code as defined in the JPEG 2000 Standard.
